(19) United States
(12) Patent Application Publication
(10) Pub. No.: US 2025/0181125 A1
(43) Pub. Date: Jun. 5, 2025

(54) MULTI-FAN SYSTEM AND OPERATING METHOD FOR MULTI-FAN SYSTEM

(71) Applicant: Midastek Microelectronics Inc., Taipei City (TW)

(72) Inventors: Hsin-Chuan Lai, Taipei City (TW); Chung-Ping Tan, Taipei City (TW)

(73) Assignee: Midastek Microelectronics Inc., Taipei City (TW)

(21) Appl. No.: 18/963,394

(22) Filed: Nov. 27, 2024

(30) Foreign Application Priority Data
Nov. 30, 2023 (TW) 112146544

(51) Int. Cl. G06F 1/20

(52) U.S. Cl. CPC G06F 1/20

(57) ABSTRACT

A multi-fan system and an operating method for the multi-fan system are provided. The multi-fan system includes a control source circuit and a plurality of fan devices. The control source circuit provides a first data string during a first period and provides a second data string during a second period. The first data string includes a plurality of identification code signals. The second data string includes a plurality of driving data corresponding to different identification code signals. The fan devices sequentially receive one of the identification code signals according to the first data string during the first period to obtain a corresponding identification code signal. The fan devices sequentially receive driving data corresponding to the received identification code signal according to the second data string, so as to operate using the received driving data.

### REFERENCE TO RELATED APPLICATION

This application claims the priority benefit of Taiwan application serial no. 112146544, filed on Nov. 30, 2023. The entirety of the above-mentioned patent application is hereby incorporated by reference herein and made a part of specification.

### BACKGROUND

### Technical Field

The disclosure generally relates to an electronic system and an operating method for the electronic system, and more particularly to a multi-fan system and an operating method for the multi-fan system.

### Description of Related Art

Generally, a multi-fan system is widely used in many application fields. However, in the multi-fan system, how to implement operation protocols among fan devices is still a challenge. Traditional methods may require a large number of communication lines and complex control modules, a cost and a design difficulty of the multi-fan system are increased.

### SUMMARY

The disclosure provides a multi-fan system and an operating method for the multi-fan system, which can provide a setting for operations between fan devices.

The multi-fan system of the disclosure includes a control source circuit and a plurality of fan devices. The control source circuit provides a first data string during a first period and provides a second data string during a second period. The first data string includes a plurality of identification code signals. The second data string includes a plurality of driving data corresponding to different identification code signals. The fan devices sequentially receive one of the identification code signals according to the first data string during the first period to obtain the corresponding identification code signal. The fan devices sequentially receive driving data corresponding to the received identification code signal according to the second data string, so as to operate using the received driving data.

The operating method of the disclosure is used for the multi-fan system. The multi-fan system of the disclosure includes a control source circuit and a plurality of fan devices. The operating method includes: providing, by the control source circuit, a first data string during a first period, wherein the first data string includes a plurality of identification code signals; sequentially receiving, by the fan devices, one of the identification code signals according to the first data string during the first period, so as to obtain a corresponding identification code signal; providing, by the control source circuit, a second data string during a second period, wherein the second data string includes the identification code signals and a plurality of driving data corresponding to the identification code signals; and sequentially receiving, by the fan devices, driving data corresponding to received identification code signal according to the second data string during the second period, so as to operate using the received driving data.

Based on the above, the fan devices sequentially receive one of the identification code signals according to the first data string during the first period, and sequentially receive one of the identification code signal corresponding to the received identification code signal according to the second data string during the second period, so as to operate using the received driving data. Therefore, once the corresponding driving data is received, the fan devices respectively operate based on the operation protocol of the second data string. In this way, a cost and a design difficulty of the multi-fan system could be reduced.

To make the aforementioned more comprehensible, several embodiments accompanied with drawings are described in detail as follows.

### BRIEF DESCRIPTION OF THE DRAWINGS

FIG. 1 illustrates a schematic diagram of a multi-fan system according to an embodiment of the disclosure.

FIG. 2 illustrates a schematic diagram of data strings according to an embodiment of the disclosure.

FIG. 3 illustrates a waveform diagram of an identification code signal according to an embodiment of the disclosure.

FIG. 4 illustrates a flow chart of an operating method according to an embodiment of the disclosure.

FIG. 5 illustrates a schematic diagram a fan device according to an embodiment of the disclosure.

FIG. 6 illustrates a schematic diagram of a transmission switch according to an embodiment of the disclosure.

FIG. 7 illustrates a schematic diagram of a processor and a bidirectional circuit according to an embodiment of the disclosure.

FIG. 8 illustrates a schematic diagram of data strings according to an embodiment of the disclosure.

FIG. 9 illustrates a flow chart of an operating method according to an embodiment of the disclosure.

FIG. 10A and FIG. 10B illustrate a flow chart of an operating method according to an embodiment of the disclosure.

### DESCRIPTION OF THE EMBODIMENTS

A disclosure may be understood by reference to the following detailed description, taken in conjunction with the drawings as described below. It is noted that, for purposes of illustrative clarity and being easily understood by the readers, various drawings of this disclosure show a portion of an electronic device, and certain elements in various drawings may not be drawn to scale. In addition, the number and dimension of each device shown in drawings are only illustrative and are not intended to limit the scope of a disclosure.

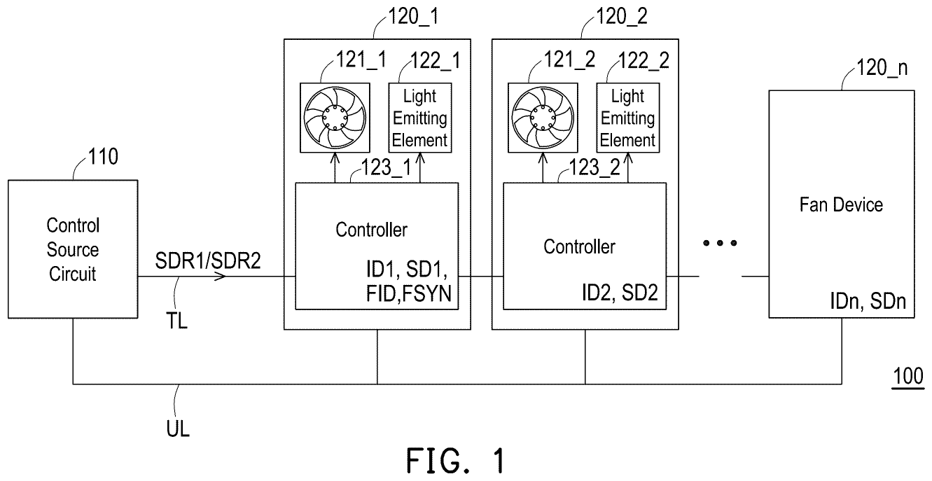

Please refer to FIG. 1, FIG. 1 illustrates a schematic diagram of a multi-fan system according to an embodiment of the disclosure. In the embodiment, the multi-fan system 100 includes a control source circuit 110 and fan devices 120_1 to 120_n. The control source circuit 110 provides a data string SDR1 during a first period and provides a data string SDR2 during a second period. The data strings SDR1 and SDR2 can be set based on different operating protocols of fan devices 120_1 to 120_n. In the embodiment, the data string SDR1 includes different identification code signals ID1 to IDn. The data string SDR2 includes the identification code signals ID1 to IDn and driving data SD1 to SDn corresponding to the identification code signals ID1 to IDn.

In the embodiment, the fan devices 120_1 to 120_n are coupled to the control source circuit 110. During the first period, the fan device 120_1 to 120_n sequentially receive the identification code signal in the data string SDR1. Therefore, the fan device 120_1 receives identification code signal ID1 during the first period. The fan device 120_2 receives identification code signal ID2 during the first period. By the same token, fan device 120_n receives the identification code signal IDn during the first period. The first period can be regarded as an identification code setting period of the fan device 120_1 to 120_n.

During the second period, the fan devices 120_1 to 120_n sequentially receive driving data corresponding to the received identification code signal according to the data string SDR2, so as to operate using the received driving data. For example, the fan device 120_1 receives the driving data SD1 corresponding to the identification code signal ID1 during the second period. The fan device 120_1 operates using the driving data SD1. The fan device 120_2 receives the driving data SD2 corresponding to the identification code signal ID2 during the second period. The fan device 120_2 operates using the driving data SD2. By the same token, the fan device 120_n receives the driving data SDn corresponding to the identification code signal IDn during the second period. The fan device 120_n operates using the driving data SDn. The second period can be regarded as a driving period of fan devices 120_1 to 120_n.

It should be noted, the fan devices 120_1 to 120_n sequentially obtain different identification code signals during the first period. The fan devices 120_1 to 120_n sequentially receive the driving data corresponding to the received identification code signal during the second period, so as to operate using the received driving data. Therefore, once the corresponding driving data is received, the fan devices 120_1 to 120_n respectively operate based on the operation protocol of data string SDR2. In this way, a cost and a design difficulty of the multi-fan system 100 could be reduced.

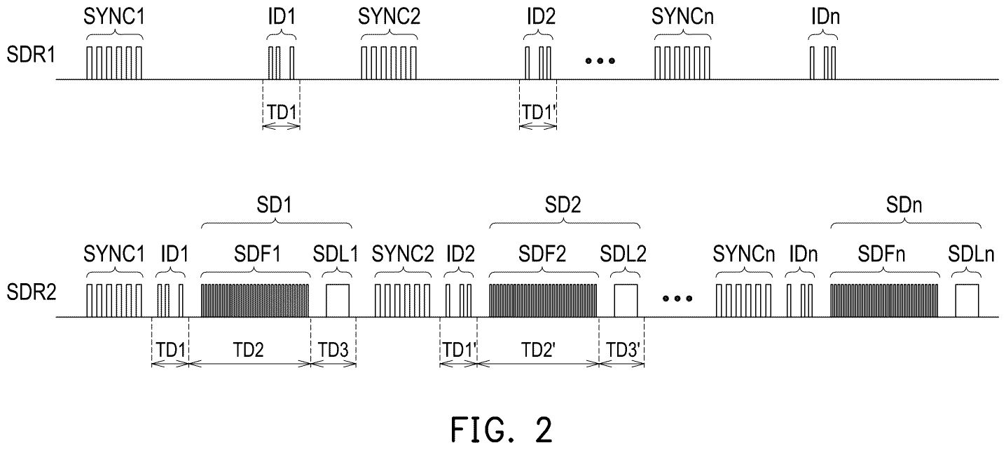

Please refer to FIG. 1 and FIG. 2, FIG. 2 illustrates a schematic diagram of data strings according to an embodiment of the disclosure. In the embodiment, FIG. 2 shows the data strings SDR1, SDR2. In the embodiment, the data string SDR1 includes synchronization signals SYNC1, SYNC2 and the identification code signals IDI to IDn. The data string SDR2 includes synchronization signals SYNC1, SYNC2, identification code signal ID1 to IDn, and driving data SD1 to SDn corresponding to identification code signal ID1 to IDn.

In the embodiment, the data string SDR1 is provided during the first period. Based on a timing of the data string SDR1, the identification code signal ID1 is after the synchronization signal SYNC1. The synchronization signal SYNC2 is after the identification code signal ID1. The identification code signal ID2 is after the synchronization signal SYNC2, and so on. Therefore, the fan device 120_1 may start receiving the identification code signal ID1 according to the synchronization signal SYNC1. When the reception of the identification code signal ID1 is completed, the fan device 120_1 transmits the data string SDR1 to the fan device 120_2. Therefore, based on the timing of the data string SDR1, the fan device 120_2 does not receive the synchronization signal SYNC1 and the identification code signal ID1. The fan device 120_2 starts receiving the identification code signal ID2 according to the synchronization signal SYNC2. When the reception of the identification code signal ID2 is completed, the fan device 120_2 transmits the data string SDR1 to next fan device.

In the embodiment, the data string SDR2 is provided during the second period after the first period. Based on the timing of the data string SDR2, the identification code signal ID1 is after the synchronization signal SYNC1. The driving data SD1 is after the identification code signal ID1. The synchronize signal SYNC2 is after the driving data SD1. The identification code signal ID1 is after the synchronization signal SYNC2. The driving data SD2 is after the identification code signal ID2. The driving data SD1 includes a fan driving signal SDF1 and a light emitting driving signal SDL1. The driving data SD2 includes a fan driving signal SDF2 and a light emitting driving signal SDL2.

In the embodiment, the fan device 120_1 includes a fan element 121_1, a light emitting element 122_1 and a controller 123_1. The controller 123_1 is coupled to the fan element 121_1 and the light emitting element 122_1. During the first period, the controller 123_1 receives data string SDR1 first. The controller 123_1 determines whether the synchronization signal SYNC1 is received. When receiving the synchronization signal SYNC1, the controller 123_1 receives the identification code signal ID1 within a predetermined period TD1. Once the reception of the identification code signal ID1 is completed, the controller 123_1 obtains the identification code corresponding to the identification code signal ID1 and transmits the data string SDR1 to the fan device 120_2.

The fan device 120_2 includes a fan element 121_2, a light emitting element 122_2 and a controller 123_2. The controller 123_2 is coupled to the fan element 121_2 and the light emitting element 122_2. The controller 123_2 determines whether the synchronization signal SYNC2 is received. When receiving the synchronization signal SYNC2, the controller 123_2 receives the identification code signal ID2 within a predetermined period TD1′. Once the reception of the identification code signal ID2 is completed, the controller 123_2 obtains the identification code corresponding to the identification code signal ID2 and transmits the data string SDR1 to the next fan device.

During the second period, the controller 123_1 receives the data string SDR2. After receiving the identification code signal ID1, the controller 123_1 uses the driving data SD1 to drive the fan element 121_1 and the light emitting element 122_1 within predetermined periods TD2 and TD3. Furthermore, the controller 123_1 uses the fan driving signal SDF1 to drive the fan element 121_1 within the predetermined period TD2 and uses the light emitting driving signal SDL1 to drive the light emitting element 122_1 within the predetermined period TD3. In the embodiment, the identification code signal ID1 has a fixed pulse number. The fan driving signal SDF1 and the light driving signal SDL1 have a header signal and a trailer signal respectively. Therefore, controller 123_1 can use the pulse number to determine whether the complete identification code signal ID1 is received. Controller 123_1 can use the tail signal to determine whether it has received the complete fan driving signal SDF1 and the complete light emitting driving signal SDL1.

The controller 123_2 receives the data string SDR2. After receiving the identification code signal ID2, the controller 123_2 uses the driving data SD2 to drive the fan element 121_2 and the light emitting element 122_2 within the predetermined period TD2′ and TD3′. Furthermore, the controller 123_2 uses the fan driving signal SDF2 to drive the fan element 121_2 within the predetermined period TD2′ and uses the light emitting driving signal SDL2 to drive the light emitting element 122_2 within the predetermined period TD3′.

In the embodiment, the control source circuit 110 may be any type of data generating device. The controllers 123_1 and 123_2 are, for example, central processing units (CPU), or other programmable general-purpose or special-purpose microprocessors (Microprocessors), digital signal processors (Digital Signal Processors, DSP), or Programmable controller, Application Specific Integrated Circuits (ASIC), Programmable Logic Device (PLD) or other similar devices or combinations of these devices, which can load and execute computer programs. The fan elements 121_1 and 121_2 are, for example, elements for providing air flow. The light emitting elements 122_1 and 122_2 are, for example, elements including at least one light emitting diode.

In some embodiments, based on actual design requirements, the light emitting elements 122_1 and 122_2 may be omitted.

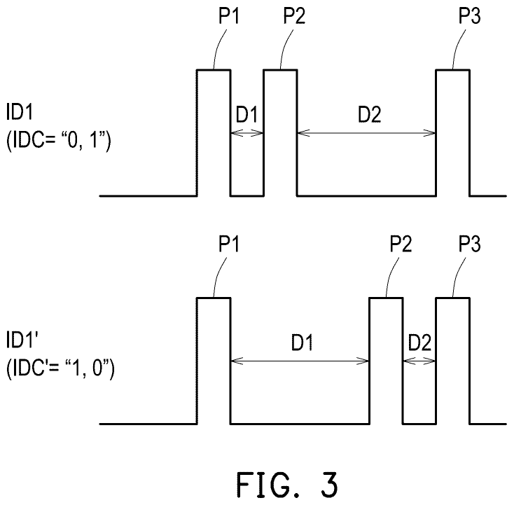

Please refer to FIG. 1 and FIG. 3, FIG. 3 illustrates a waveform diagram of an identification code signal according to an embodiment of the disclosure. In the embodiment, the identification code signal ID1 includes, for example, a plurality of pulse waves P1 to P3 (but the invention is not limited thereto). The controller 123_1 generates code values based on intervals between two adjacent pulse waves, and combines the code values into an identification code IDC. For example, the first interval distance D1 between two adjacent pulse waves P1 and P2 corresponds to the first code value (such as “0”) of the identification code IDC. The second interval distance D2 between the two adjacent pulse waves P1 and P2 corresponds to the second code value of the identification code IDC (such as “1”). The first interval distance D1 is different from the second interval distance D2. The first code value is different from the second code value. For example, controller 123_1 obtains that identification code IDC is equal to “0, 1” based on identification code signal ID1. For example, controller 123_1 obtains that identification code IDC′ is equal to “1, 0” based on identification code signal ID1′.

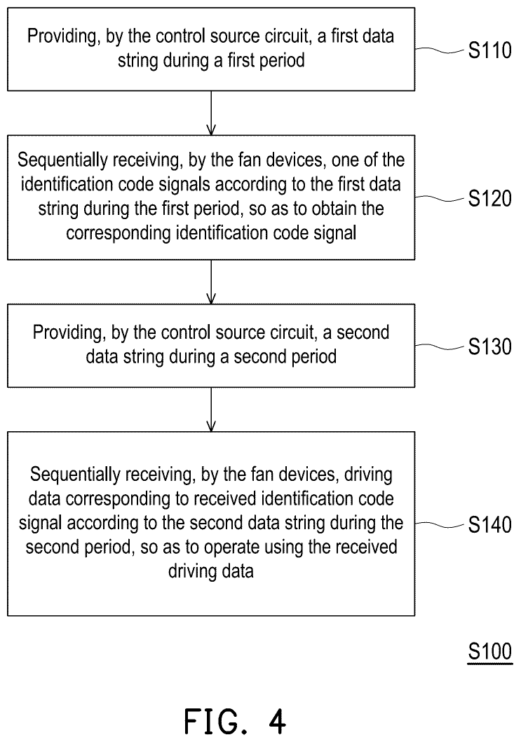

Please refer to FIG. 1 and FIG. 4, FIG. 4 illustrates a flow chart of an operating method according to an embodiment of the disclosure. In the embodiment, the operating method S100 is used for the multi-fan system 100. The operating method S100 includes steps S110 to S140. In the step S110, the control source circuit 110 provides the data string SDR1 (that is, the first data string) during the first period. In the step S120, the fan devices 120_1 to 120_n sequentially receive one of the identification code signals according to the data string SDR1 during the first period to obtain the corresponding identification code signal. In the step S130, the control source circuit 110 provides the data string SDR2 (that is, the second data string) during the second period. In the step S140, the fan devices 120_1 to 120_n sequentially receive driving data corresponding to the received identification code signal according to the data string SDR2 during the second period, so as to operate using the received driving data.

The implementation details of the steps S110 to S140 have been clearly explained in the embodiments of FIG. 1 to FIG. 3, so it will not be repeated here.

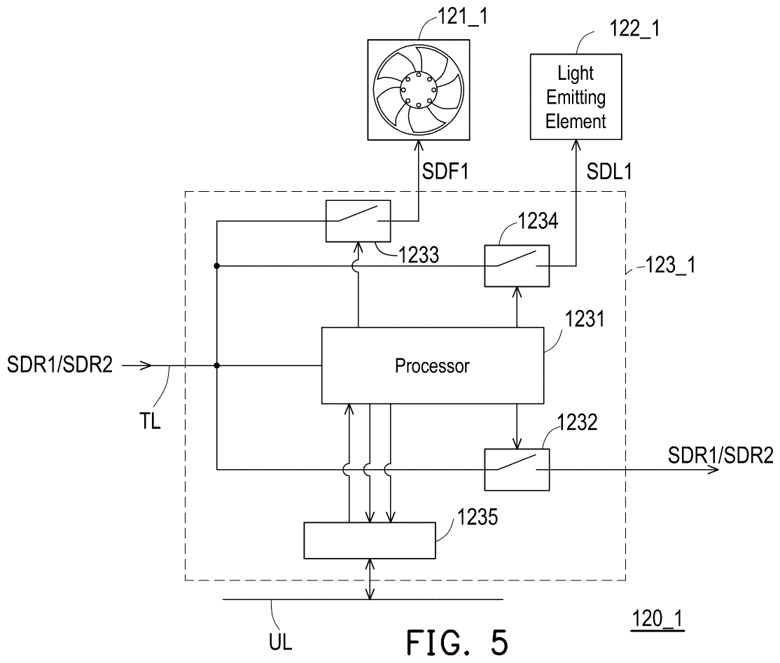

Please refer to FIG. 1, FIG. 2 and FIG. 5, FIG. 5 illustrates a schematic diagram a fan device according to an embodiment of the disclosure. In the embodiment, the fan device 120_1 includes the fan element 121_1, the light emitting element 122_1 and the controller 123_1. The controller 123_1 includes a processor 1231. The processor 1231 determines whether the synchronization signal SYNC1 is received during the first period. When receiving the synchronization signal SYNC1, the processor 1231 receives the identification code signal ID1 within the predetermined period TD1.

The controller 123_1 further includes a transmission switch 1232. A first terminal of the transmission switch 1232 receives one of the data strings SDR1 and SDR2. A second terminal of the transmission switch 1232 is coupled to the next fan device. A control terminal of the transmission switch 1232 is coupled to the processor 1231. During the first period and the second period, after the controller 123_1 completes receiving the identification code signal ID1, the processor 1231 turns on the transmission switch 1232.

The controller 123_1 further includes driving switches 1233 and 1234. A first terminal of the driving switch 1233 receives data string SDR2. A second terminal of the driving switch 1233 is coupled to the fan element 121_1. A control terminal of the driving switch 1233 is coupled to the processor 1231. A first terminal of driving switch 1234 receives data string SDR2. A second terminal of the driving switch 1234 is coupled to the light emitting element 122_1. A control terminal of the driving switch 1234 is coupled to the processor 1231. When receiving the identification code signal ID1 in the data string SDR2, the processor 1231 turns on the driving switch 1233 within the predetermined period TD2 to drive the fan element 121_1 using the driving data SD1, and turns on the driving switch 1234 within the predetermined period TD3 to drive light emitting element 122_1 using the driving data SD1.

It should be noted, when the driving switch 1233 is turned on, the fan element 121_1 operates by receiving the fan driving signal SDF1 in the data string SDR2. When the driving switch 1234 is turned on, the light emitting element 122_1 operates by receiving the emitting driving signal SDL1 in the data string SDR2. The processor 1231 does not provide the fan driving signal SDF1 and the lighting driving signal SDL1. Therefore, the fan driving signal SDF1 does not need to be sent to the fan element 121_1 through the processor 1231. The light emitting driving signal SDL1 does not need to be sent to the light emitting element 122_1 through the processor 1231. In this way, the running start time points of fan element 121_1 and light emitting element 122_1 could be advanced.

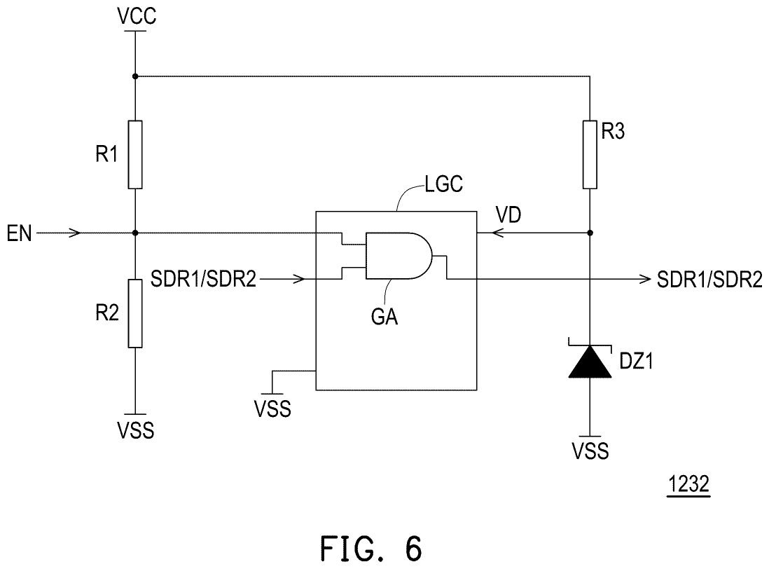

Please refer to FIG. 1, FIG. 5 and FIG. 6, FIG. 6 illustrates a schematic diagram of a transmission switch according to an embodiment of the disclosure. In the embodiment, the transmission switch 1232 includes resistors R1, R2 and a logic circuit LGC. Taking this embodiment as an example, the logic circuit LGC includes an AND gate GA. A first input terminal of the AND gate GA is coupled to the processor 1231 to receive the enable signal EN provided by the processor 1231. The second input terminal of the AND gate GA is coupled to the first terminal of the transmission switch 1232 to receive one of the data strings SDR1 and SDR2. The output terminal of the AND gate GA is coupled to the second terminal of the transmission switch 1232. The resistor R1 is coupled between a system high voltage VCC and the first input terminal of the AND gate GA. The resistor R2 is coupled between the first input terminal of the AND gate GA and a system low voltage VSS (for example, ground).

In the embodiment, the processor 1231 may provide an enable signal EN having a low logic level to cause the second terminal of the transmission switch 1232 to output a signal having a low logic level. Therefore, the transmission switch 1232 enters the “OFF” state to stop transmitting the data strings SDR1 and SDR2. The processor 1231 can provide an enable signal EN having a high logic level to make the signal output by the second terminal of the transmission switch 1232 equal to one of the data strings SDR1 and SDR2. Therefore, the transmission switch 1232 enters the “ON” state to transmit one of the data strings SDR1 and SDR2.

When an exception occurs in the processor 1231, the processor 1231 provides a high-impedance (Hi-Z) signal and is unable to provide an enable signal EN having a high logic level. It should be noted, the resistors R1 and R2 can provide a divided voltage signal of the system high voltage VCC to the first input terminal of the AND gate GA, thereby causing the transmission switch 1232 to enter the “on” state. In other words, when the exception occurs in the processor 1231, the transmission switch 1232 enters the “on” state to transmit one of the data strings SDR1 and SDR2. In this way, when the exception occurs in the processor 1231, the fan devices 120_2 to 120_n can also receive one of the data strings SDR1 and SDR2.

In the embodiment, the transmission switch 1232 further includes a resistor R3 and a clamping element DZ1. The resistor R3 is coupled between the system high voltage VCC and the power input terminal of the logic circuit LGC. The resistor R3 is used to limit the value of the power supply current input to a power input terminal of the logic circuit LGC. The clamping element DZ1 is, for example, a Zener diode. The cathode of the clamping element DZ1 is coupled to the power input terminal of the logic circuit LGC. The anode of the clamping element DZ1 is coupled to the system low voltage VSS. The clamping element DZ1 is used to clamp the power supply voltage value VD input to the power input terminal of the logic circuit LGC. In this way, the logic circuit LGC can receive stable power.

In some embodiments, the transmission switches of fan devices 120_2 to 120_n can also have a circuit design similar to this embodiment.

Please refer to FIG. 1 and FIG. 5, in the embodiment, the controller 123_1 further includes a bidirectional circuit 1235. The bidirectional circuit 1235 is coupled to the control source circuit 110 and the processor 1231. The bidirectional circuit 1235 transmits a command CMD1 from the control source circuit 110 to the processor 1231 and transmits an information from the processor 1231 to the control source circuit 110. Furthermore, the information provided by the processor 1231 may be an operation result data of the fan device 120_1. The bidirectional circuit 1235 can be connected to the control source circuit 110 through a transmission line UL. The transmission line UL may be a Universal Asynchronous Receiver/Transmitter (UART) transmission line, but the disclosure is not limited thereto.

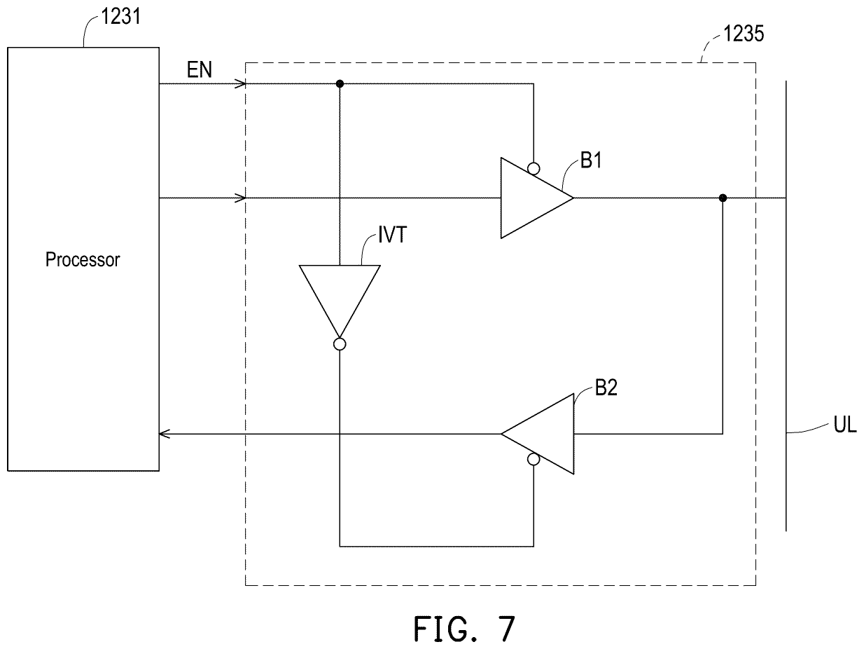

For further explanation, please refer to FIG. 1, FIG. 5 and FIG. 7, FIG. 7 illustrates a schematic diagram of a processor and a bidirectional circuit according to an embodiment of the disclosure. In the embodiment, the bidirectional circuit 1235 includes buffers B1, B2 and an inverter IVT. An input terminal of the buffer B1 is coupled to a sending terminal of the processor 1231. An output terminal of the buffer B1 is coupled to the transmission line UL. A control terminal of the buffer B1 is coupled to the processor 1231 to receive the enable signal EN from the processor 1231. An input end of the buffer B2 is coupled to the transmission line UL. An output terminal of the buffer B2 is coupled to a receiving terminal of the processor 1231. An input terminal of the inverter IVT is coupled to the control terminal of the buffer B1 and receives enable signal EN. The output terminal of the inverter IVT is coupled to a control terminal of the buffer B2. Therefore, buffers B1 and B2 would not transmit signals at the same time.

The processor 1231 enables the buffer B2 and disables the buffer B1. Therefore, the control source circuit 110 can provide commands or data strings SDR1 and SDR2 to the receiving terminal of the processor 1231. Besides, the processor 1231 enables the buffer B1 and disables the buffer B2. Therefore, the processor 1231 could report operating status of the fan element 121_1 and the light emitting element 122_1 and/or the information of the fan device 120_1 to the control source circuit 110.

The output terminal of buffer B1 and the input terminal of buffer B2 are respectively coupled to the transmission line UL.

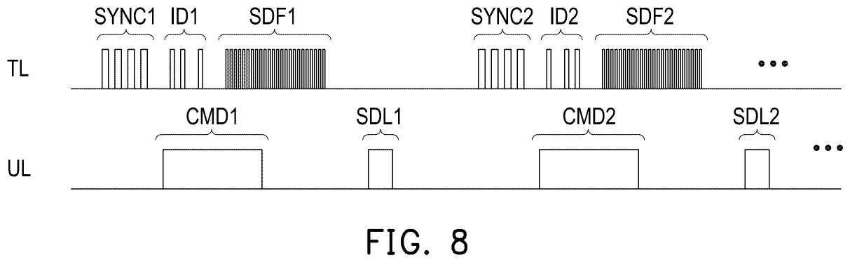

Please refer to FIG. 1 and FIG. 8, FIG. 8 illustrates a schematic diagram of data strings according to an embodiment of the disclosure. In the embodiment, the transmission line TL may be a PWM signal line. The transmission line UL may be a FG signal line. In the embodiment, the transmission line TL is used to transmit synchronization signals SYNC1, SYNC2, fan driving signals SDF1, SDF2, and identification code signals ID1, ID2. The transmission line UL is used to transmit light emitting driving signals SDL1, SDL2, commands CMD1, CMD2, and reporting information (not shown) from the fan devices 120_1 to 120_n.

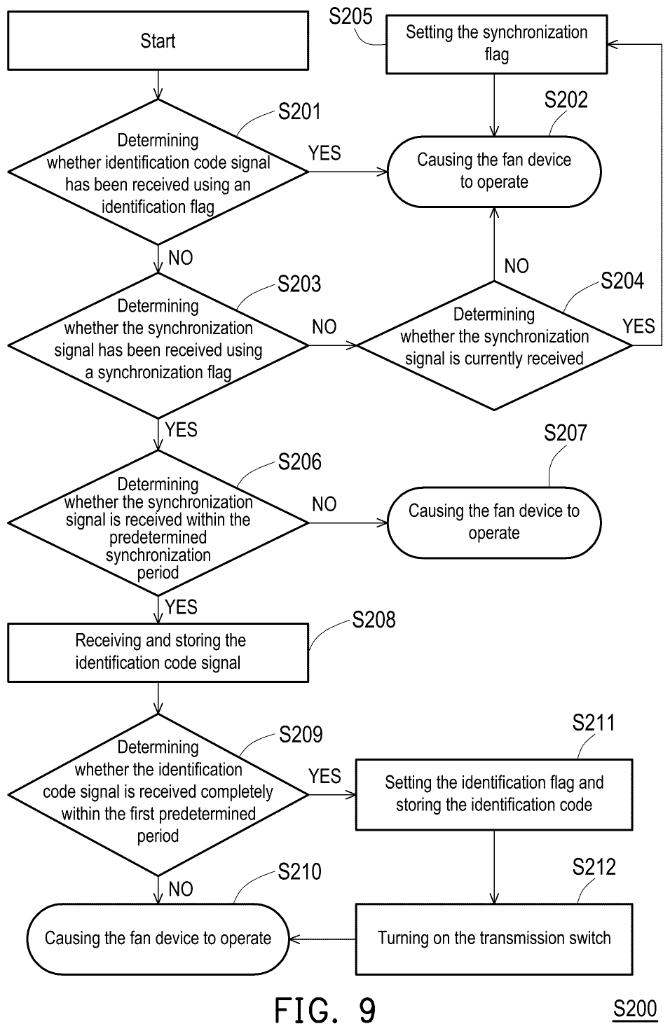

Please refer to FIG. 1, FIG. 2 and FIG. 9, FIG. 9 illustrates a flow chart of an operating method according to an embodiment of the disclosure. In the embodiment, during the first period, the operating method S200 may be used for one of the fan devices 120_1 to 120_n of the multi-fan system 100. The operating method S200 includes steps S201 to S212. Taking fan device 120_1 as an example, after fan device 120_1 is started, controller 123_1 uses an identification flag FID to determine whether identification code signal ID1 has been received in the step S201. A first value of the identification flag FID corresponds to a status value for which the identification code signal ID1 has not yet been received. A second value of the identification flag FID corresponds to a status value for which the identification code signal ID1 has been received. Thus, the controller 123_1 may use the status value of identification flag FID to determine whether the identification code signal ID1 has been received. When the controller 123_1 determines that the identification code signal ID1 has been completely received using the identification flag FID having the second value, the controller 123_1 causes the fan device 120_1 to operate in the step S202. The fan device 120_1 operates using the fan driving signal SDF1 and the lighting driving signal SDL1 received previously.

On the other hand, when the controller 123_1 determines that the identification code signal ID1 has not been received using the identification flag FID having the first value, the controller 123_1 determines whether the synchronization signal SYNC1 has been received using a synchronization flag FSYN in the step S203. A first value of the synchronization flag FSYN corresponds to the status value of the synchronization signal SYNC1 that has not yet been received. A second value of the synchronization flag FSYN corresponds to the status value of the synchronization signal SYNC1 that has been received. Therefore, the controller 123_1 could use the value of the synchronization flag FSYN to determine whether the synchronization signal SYNC1 is received. When the controller 123_1 determines that the synchronization signal SYNC1 has not been received by using the synchronization flag FSYN having the first value, the controller 123_1 determines whether the synchronization signal SYNC1 is currently received in the step S204. When the synchronization signal SYNC1 is not currently received, the controller 123_1 causes the fan device 120_1 to operate in the step S202. When the synchronization signal SYNC1 is currently received, the controller 123_1 sets the first value of the synchronization flag FSYN to the second value in the step S205, and then causes the fan device 120_1 to operate in the step S202.

In the step S203, when the controller 123_1 determines that the synchronization signal SYNC1 has been previously received using the synchronization flag FSYN with the second value, the controller 123_1 receives the synchronization signal SYNC1 again in the step S206, and determines whether the synchronization signal SYNC1 is received within the predetermined synchronization period, so as to determine whether the synchronization signal SYNC1 is correct. When the controller 123_1 does not receive the synchronization signal SYNC1 within the predetermined synchronization period, this means that the previously received synchronization signal SYNC1 is incorrect. Therefore, the controller 123_1 will not receive the identification code signal ID1, the fan driving signal SDF1 and the lighting driving signal SDL1 after the current synchronization signal SYNC1. Next, the controller 123_1 causes the fan device 120_1 to operate in the step S207. The fan device 120_1 can operate using the fan driving signal SDF1 and the lighting driving signal SDL1 received previously.

On the other hand, when the controller 123_1 receives the complete synchronization signal SYNC1 within the predetermined synchronization period, the controller 123_1 receives and stores the identification code signal ID1 in the step S208, and determines that the complete synchronization signal SYNC1 is within the predetermined period TD1 (that is, determines whether the identification code signal ID1 is received completely within the first predetermined period) in the step S209. In the step S208, the controller 123_1 may obtain the identification code according to the identification code signal ID1, and count the number of bits of the identification code. When the number of bits of the identification code has not reached the predetermined value within the predetermined period TD1, this means that the controller 123_1 has not received the complete identification code signal ID1 within the predetermined period TD1, and cannot obtain the complete identification code. Therefore, the controller 123_1 causes the fan device 120_1 to operate in the step S210. For example, the fan device 120_1 can operate using the previously received fan driving signal SDF1 and light emitting driving signal SDL1.

On the other hand, when the number of bits of the identification code reaches the predetermined value within the predetermined period TD1, it means that the controller 123_1 receives the complete identification code signal ID1 within the predetermined period TD1 and obtains the complete identification code. Therefore, the controller 123_1 sets the first value of the identification flag FID to the second value and stores the identification code in the step S211. The controller 123_1 turns on the transmission switch 1232 in the step S212. Next, the controller 123_1 causes the fan device 120_1 to operate in the step S210. It should be noted, the fan device 120_1 operates with the new fan driving signal SDF1 as well as the new lighting driving signal SDL1.

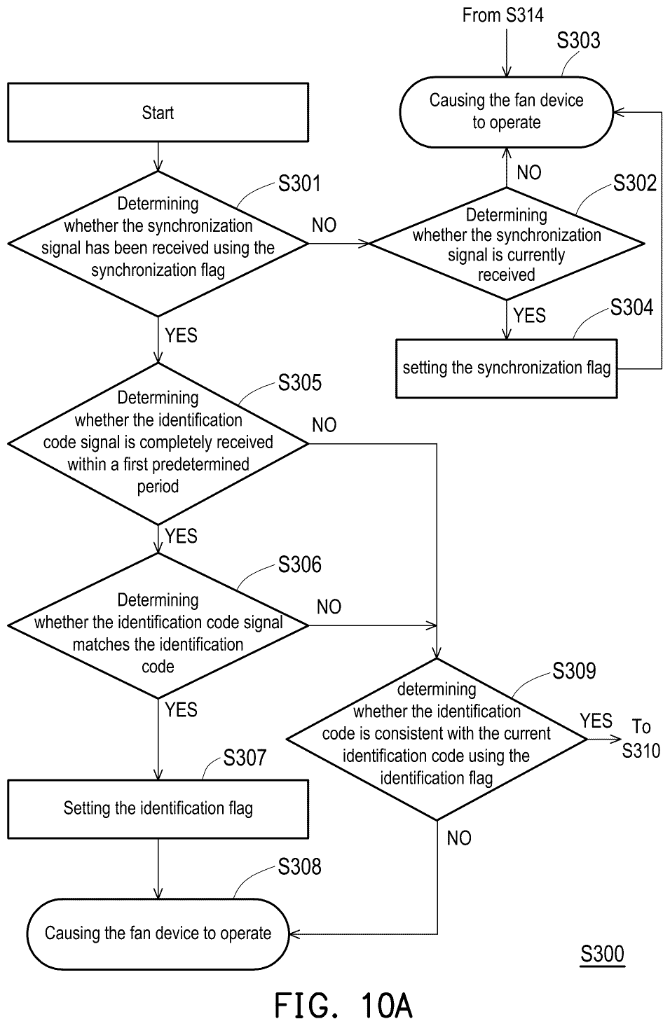

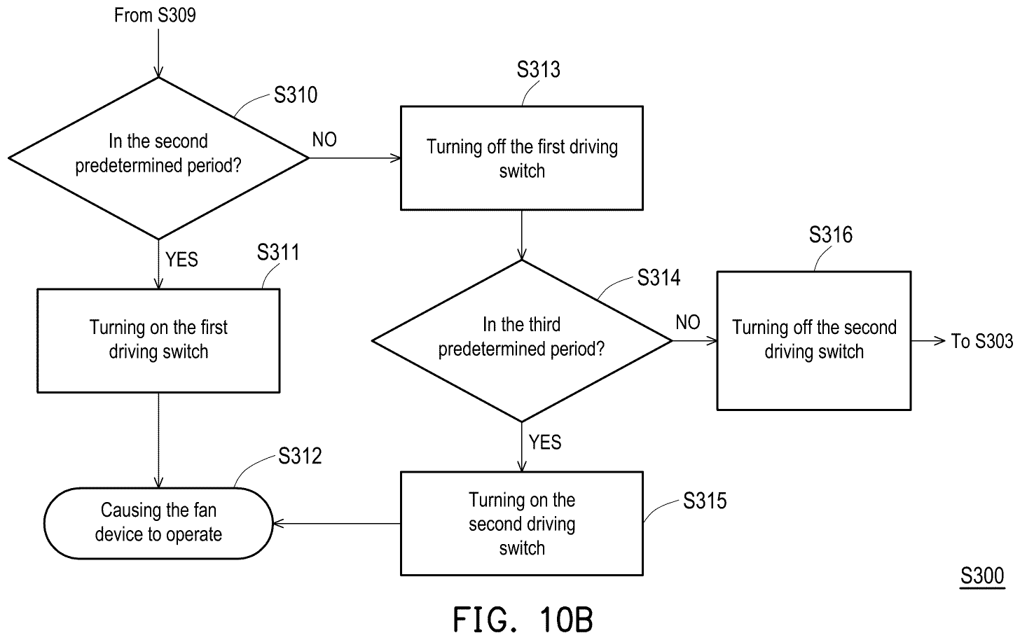

Please refer to FIG. 1, FIG. 5, FIG. 10A and FIG. 10B, FIG. 10A and FIG. 10B illustrate a flow chart of an operating method according to an embodiment of the disclosure. In the embodiment, during the second period, the operating method S300 may be used for one of the fan devices 120_1 to 120_n of the multi-fan system 100. The operating method S300 includes steps S301 to S316. Taking fan device 120_1 as an example, the processor 1231 uses the synchronization flag FSYN to determines whether the synchronization signal SYNC1 has been received in the step S301. When the processor 1231 determines that the synchronization signal SYNC1 has not been received using the synchronization flag FSYN, the processor 1231 determines whether the synchronization signal SYNC1 is currently received in the step S302. When the synchronization signal SYNC1 is not currently received, the processor 1231 turns off the driving switches 1233 and 1234. For example, the fan device 120_1 may operate using the previously received fan driving signal SDF1 and light emitting driving signal SDL1. When the synchronization signal SYNC1 is currently received, the processor 1231 sets the first value of the synchronization flag FSYN to the second value in the step S304, and then causes the fan device 120_1 to operate in the step S303.

In the step S301, when the processor 1231 determines that the synchronization signal SYNC1 has been previously received using the synchronization flag FSYN, the processor 1231 determines whether the identification code signal ID1 is completely received within the predetermined period TD1 in the step S305. When the processor 1231 has completely received the identification code signal ID1 within the predetermined period TD1, the processor 1231 determines whether the identification code signal ID1 matches the identification code IDC in the step S306. When the identification code signal ID1 matches the identification code IDC, the processor 1231 sets the first value of the identification flag FID to the second value in the step S307, and then causes the fan device 120_1 to operate in the step S308.

In the step S305, when the processor 1231 does not completely receive the identification code signal ID1 within the predetermined period TD1, the processor 1231 enters an operation in step S309. In step S306, when the identification code signal ID1 matches the identification code IDC, the processor 1231 also enter the operation in the step S309.

In the step S309, the processor 1231 uses the identification flag FID to determine whether the identification code IDC (that is, the previous identification code IDC) is consistent with the current identification code IDC. When the processor 1231 uses the identification flag FID with the first value to determine that the previous identification code IDC is inconsistent with the current identification code IDC, this means that the processor 1231 has not received an identification code consistent with the current identification code so far, signal ID1. Therefore, the processor 1231 causes the fan device 120_1 to operate in step S308. In the above situation, the fan device 120_1 can operate using the previously received fan driving signal SDF1 and light emitting driving signal SDL1.

On the other hand, in the step S309, when the processor 1231 determines that the previous identification code IDC is consistent with the current identification code using the identification flag FID with the second value, the processor 1231 determines whether the predetermined time period TD2 has entered in the step S310. When entering the predetermined period TD2 (that is, the second predetermined period), the processor 1231 turns on the driving switch 1233 (that is, the first driving switch) in the step S311, and causes the fan device 120_1 to operate according to the fan driving signal in the step S312. SDF1 to operate. When it is not within the predetermined period TD2, the processor 1231 turns off the driving switch 1233 in the step S313.

In the step S314, the processor 1231 determines whether it enters the predetermined period TD3 (i.e., the third predetermined period). When entering the predetermined period TD3, the processor 1231 turns on the driving switch 1234 (that is, the second driving switch) in the step S315, and causes the fan device 120_1 to operate according to the light emitting driving signal SDL1 in the step S312. When it is not within the predetermined period TD3, the processor 1231 turns off the driving switch 1234 in the step S316, and causes the fan device 120_1 to operate in the step S303.

In view of the foregoing, the multiple fan devices first obtain different identification code signals in sequence during the first period. Next, the plurality of fan devices sequentially receive the driving data corresponding to the received identification code signal during the second period to operate using the received driving data. Therefore, once the corresponding driving data is received, the plurality of fan devices respectively operate based on the operation protocol of the second data string. In this way, the cost and design difficulty of the multi-fan system will be reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A multi-fan system, comprising:
a control source circuit, configured to provide a first data string during a first period and provide a second data string during a second period, wherein the first data string comprises a plurality of identification code signals, wherein the second data string comprises the plurality of identification code signals and a plurality of driving data corresponding to the identification code signals; and
a plurality of fan devices, coupled to the control source circuit, and configured to:
sequentially receive one of the identification code signals according to the first data string during the first period to obtain the corresponding identification code signal, and
sequentially receive driving data corresponding to the received identification code signal according to the second data string, so as to operate using the received driving data.

2. The multi-fan system of claim 1, wherein:
the first data string comprises a first identification code signal and a second identification code signal, and
during the first period, after a first fan device among the plurality of fan devices has completed receiving the first identification code signal, the first fan device transmits the first data string to a second fan device among the plurality of fan devices, so that the second fan device receives the second identification code signal.

3. The multi-fan system of claim 2, wherein the second data string further comprises a first synchronization signal and a first driving data corresponding to the first identification code signal.

4. The multi-fan system of claim 3, wherein the first fan device comprises:
a fan element;
a light emitting element; and
a controller, coupled to the fan element and the light emitting element, wherein the controller comprises:
a processor, configured to determine whether the first synchronization signal is received during the first period, and receive the first identification code signal within a first predetermined period when the first synchronization signal is received.

5. The multi-fan system of claim 4, wherein the controller further comprises:
a transmission switch, a first terminal of the transmission switch receives one of the first data string and the second data string, a second terminal of the transmission switch is coupled to the second fan device, a control terminal of the transmission switch is coupled to the processor,
wherein during the first period and the second period, after the controller completes receiving the first identification code signal, the processor turns on the transmission switch.

6. The multi-fan system of claim 4, wherein the controller further comprises:
a first driving switch, a first terminal of the first driving switch receives the second data string, a second terminal of the first driving switch is coupled to the fan element, a control terminal of the first driving switch is coupled to the processor; and
a second driving switch, a first terminal of the second driving switch receives the second data string, a second terminal of the second driving switch is coupled to the light emitting element, a control terminal of the second driving switch is coupled to the processor.

7. The multi-fan system of claim 6, wherein during the second period:
when receiving the first identification code signal in the second data string, the processor turns on the first driving switch within a second predetermined period to drive the fan element using the first driving data, and turn on the second driving switch within a third predetermined period to drive the light emitting element using the first driving data.

8. The multi-fan system of claim 4, wherein the controller further comprises:
a bidirectional circuit, coupled to the control source circuit and the processor, and configured to transmit a command from the control source circuit to the processor and transmit an information from the processor to the control source circuit.

9. The multi-fan system of claim 8, wherein the bidirectional circuit comprises:
a first buffer, an input terminal of the first buffer is coupled to a sending terminal of the processor, an output terminal of the first buffer is coupled to a transmission line, a control terminal of the first buffer is coupled to the controller to receive an enable signal from the controller;
a second buffer, an input terminal of the second buffer is coupled to the transmission line, an output terminal of the second buffer is coupled to a receiving terminal of the processor; and
an inverter, an input terminal of the inverter is coupled to the control terminal of the first buffer and receives the enable signal, an output terminal of the inverter is coupled to a control terminal of the second buffer.

10. The multi-fan system of claim 4, wherein:
the first identification code signal comprises a plurality of pulses, and
the processor generates a plurality of code values based on a plurality of interval distances between two adjacent pulse waves among the plurality of pulses, and combines the plurality of code values into an identification code.

11. The multi-fan system of claim 10, further comprising:
a first interval distance between two adjacent pulse waves corresponds to a first code value of the identification code,
a second interval distance between two adjacent pulse waves corresponds to a second code value of the identification code,
the first interval distance is different from the second interval distance, and
the first code value is different from the second code value.

12. The multi-fan system of claim 4, wherein:
the first driving data comprises a fan driving signal and a light emitting driving signal,
the control source circuit transmits the first synchronization signal, the first identification code signal and the fan driving signal through a first transmission line, and
the control source circuit transmits the light emitting driving signal through a second transmission line.

13. An operating method for a multi-fan system, wherein the multi-fan system comprises a control source circuit and a plurality of fan devices, wherein the operating method comprises:
providing, by the control source circuit, a first data string during a first period, wherein the first data string includes a plurality of identification code signals;
sequentially receiving, by the plurality of fan devices, one of the plurality of identification code signals according to the first data string during the first period, so as to obtain a corresponding identification code signal;
providing, by the control source circuit, a second data string during a second period, wherein the second data string includes the plurality of identification code signals and a plurality of driving data corresponding to the plurality of identification code signals; and
sequentially receiving, by the plurality of fan devices, driving data corresponding to received identification code signal according to the second data string during the second period, so as to operate using the received driving data.

14. The operating method of claim 13, wherein the first data string comprises a first identification code signal and a second identification code signal, wherein the step of obtaining the corresponding identification code signal comprises:
during the first period, after a first fan device among the plurality of fan devices has completed receiving the first identification code signal, transmitting, by the first fan device, the first data string to a second fan device among the plurality of fan devices, so that the second fan device receives the second identification code signal.

15. The operating method of claim 14, wherein the second data string further comprises a first synchronization signal and a first driving data corresponding to the first identification code signal.

16. The operating method of claim 15, wherein the first fan device comprises a fan element, a light emitting element and a controller, wherein the controller is coupled to the fan element and the light emitting element, wherein the step of obtaining the corresponding identification code signal comprises:
determining, by the controller, whether the first synchronization signal is received during the first period; and
receiving, by the controller, the first identification code signal within a first predetermined period when the first synchronization signal is received.

17. The operating method of claim 16, wherein the controller comprises a transmission switch, wherein a first terminal of the transmission switch receives one of the first data string and the second data string, wherein a second terminal of the transmission switch is coupled to the second fan device, wherein the step of transmitting, by the first fan device, the first data string to the second fan device among the plurality of fan devices comprises:
during the first period and the second period, turning on the transmission switch after the controller completes receiving the first identification code signal.

18. The operating method of claim 17, wherein the controller further comprises a first driving switch and a second driving switch, wherein a first terminal of the first driving switch receives the second data string, wherein a second terminal of the first driving switch is coupled to the fan element, wherein a first terminal of the second driving switch receives the second data string, wherein a second terminal of the second driving switch is coupled to the light emitting element, wherein the step of operating using the received driving data comprises:
when receiving the first identification code signal in the second data string, turning on the first driving switch within a second predetermined period to drive the fan element using the first driving data, and turning on the second driving switch within a third predetermined period to drive the light emitting element using the first driving data.

19. The operating method of claim 14, wherein the first identification code signal comprises a plurality of pulses, wherein the operating method further comprises:
generating a plurality of code values based on a plurality of interval distances between two adjacent pulse waves among the plurality of pulses, and combining the plurality of code values into an identification code.

20. The operating method of claim 19, wherein:
a first interval distance between two adjacent pulse waves corresponds to a first code value of the identification code,
a second interval distance between two adjacent pulse waves corresponds to a second code value of the identification code,
the first interval distance is different from the second interval distance, and
the first code value is different from the second code value.
